(19) United States
(12) Patent Application Publication
(10) Pub. No.: US 2026/0273487 A1
(43) Pub. Date: Sep. 17, 2026

(54) PLANT FOR THE TREATMENT OF MATERIAL CONTAINING A CARONACEOUS MATRIX AND ITS OPERATION METHOD

(71) Applicant: PYROGAS ENGINEERING S.R.L. SOCIETA' BENEFIT, Brindisi (IT)

(72) Inventor: Danilo Dante BONFADINI, Brindisi (IT)

(21) Appl. No.: 19/168,564

(22) PCT Filed: Apr. 4, 2024
(86) PCT No.: PCT/IB2024/053282

§ 371 Date: Sep. 24, 2025

(30) Foreign Application Priority Data
Apr. 5, 2023 (IT) 102023000006723

(51) Int. Cl. B01J 6/00; C10J 3/00

(52) U.S. Cl. CPC B01J 6/008; C10J 3/005

(57) ABSTRACT

A plant is described for the treatment of waste containing a carbonaceous matrix comprising at least: a treatment station which is configured to receive as input a carbonaceous matrix to be processed and to thermochemically decompose said carbonaceous matrix into a plurality of products in the gaseous, liquid and/or solid state; and a feeding station, which is arranged upstream of the treatment station and is adapted to conveying the carbonaceous matrix to be processed to the treatment station;
the plant enables large quantities of synthesis gas with high calorific value or large quantities of pyrolysis oil or biofuels to be obtained from waste materials or waste containing a carbonaceous matrix, depending on the calibration of the plant itself.

### CROSS-REFERENCE TO RELATED APPLICATIONS

This Patent application claims priority from Italian Patent Application No. 102023000006723 filed on Apr. 5, 2023, the entire disclosure of which is incorporated herein by reference.

### TECHNICAL SECTOR

The present invention relates to a plant for the treatment of material containing a carbonaceous matrix and the related operating method.

More specifically, the present invention relates to a plant for the production of synthesis gas, bio-fuels, carbon-based or inert material by-products and energy from waste materials containing a carbonaceous matrix, such as biomass, sewage sludge, industrial sludge, hydrocarbon suspension sludge, municipal waste, special waste and/or end-of-life tyres. The discussion that follows will make explicit reference to the use thereof without losing generality.

### BACKGROUND ART

As is known, pyrogasification is a thermochemical decomposition process for obtaining high-energy products, such as synthesis gases (syngas), heavy hydrocarbons and inert residues, from materials containing a carbonaceous matrix such as organic waste, biomass and/or the like.

More specifically, pyrogasification involves the thermal degradation at high temperatures, generally comprised between 700° C. and 800° C., of the carbonaceous matrix in the presence of a sub-stoichiometric percentage of an oxidising agent, typically oxygen.

Pyrogasification usually involves, in sequence, a drying step, a pyrolysis step and then a gasification step.

Drying essentially involves removing internal moisture from the carbonaceous matrix.

During the subsequent pyrolysis step, the dried carbonaceous matrix is thermochemically decomposed by applying heat in the absence of an oxidising agent, so that volatile compounds such as hydrogen, methane, water vapour, and heavy hydrocarbons such as aliphatic and aromatic tars are released in the liquid and/or solid state.

The subsequent gasification step, on the other hand, involves introducing a limited amount of an oxidising agent, typically oxygen, into the reactor in a sub-stoichiometric ratio, so that some of the organic material burns producing micro-combustion and providing thermal energy.

More specifically, gasification in reactors of the known type consists of two fundamental reactions, namely oxidation and reduction.

During oxidation, which takes place at the reactor section into which the oxidising agent is supplied, oxygen is combined with carbon to form carbon dioxide.

After that, the high-carbon gases move to the reduction area of the reactor, where part of the incombustible vapours are transformed into combustible substances by the following reactions:

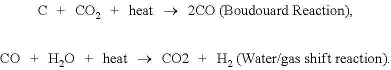

In addition, the following secondary reactions may develop during the gasification step:

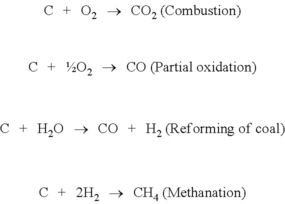

Unfortunately, in the reactors currently available on the market, the presence of low-melting ash-containing substances does not allow sufficiently high temperatures, in the order of 1200° C., to achieve complete thermal cracking of the tar and thus complete conversion of the carbonaceous matrix into synthesis gas.

In particular, reaching such temperatures would lead to the melting of the low-melting ash, compromising the functionality of the plant by generating energy losses due to reaching too high temperatures.

Nowadays, modern plants use catalysts to promote the thermal cracking of tar even at lower temperatures, allowing the process to develop even at temperatures comprised in the 800-900° C. range.

Finally, the gases obtained from the reduction step combine to form the synthesis gas (syngas).

The gasification process can be further distinguished into direct gasification and indirect gasification.

In direct gasification, the reaction occurs when an air flow is used as the gasifying agent for oxidation, and it is therefore the oxidation of the material itself that provides the energy to maintain the temperature of the process.

In indirect gasification, on the other hand, the reaction takes place using a flow of steam and oxygen, and an additional energy input from an external source is required to start the reaction.

Synthesis gas obtained by indirect gasification generally has a higher calorific value because it contains a higher concentration of hydrogen.

Gasifiers currently on the market can be distinguished into up-draft and down-draft gasifiers.

In up-draft gasifiers, the carbonaceous matrix to be treated is supplied from the top down, while the hot oxidising agent is supplied from the bottom up, allowing the incoming biomass to be pre-heated by the hot gases before the pyrolysis step. Once pyrolysis has taken place, the resulting char (consisting mainly of carbon, ash, sulphur compounds and volatile hydrocarbons) continues its downward descent to be gasified. Pyrolysis vapours containing tars are drawn upwards by the synthesis gas and may condense once in contact with the descending solid fuel at low temperature, or they may be drawn out together with the synthesis gas. The condensed tar fraction is reintroduced into the reaction area, where it undergoes the cracking process resulting in fuel gas and char.

In down-draft gasifiers, on the other hand, the carbonaceous matrix to be treated and the oxidising agent are both supplied from top to bottom and pass through a layer of solid material located in an area where the diameter of the reactor is reduced. The most common down-draft gasifiers, known as Imbert gasifiers, are characterised by a high narrowing of the throat where the air intake takes place. Most of the gasification reaction takes place at this throat, where the products are mixed in a turbulent regime at high temperature. Due to the geometric design of the reactor, there is a high conversion rate into pyrolysis products, and thus a moderate presence of tar in the synthesis gas.

Because of this characteristic, down-draft gasifiers offer good yields and are the most widely used for the thermochemical transformation of biomass.

Unfortunately, the above-mentioned pyrogasification plants have many drawbacks.

A first drawback of the pyrogasification plants described above is the difficult setting of the correct stoichiometric ratio of the oxidising agent insufflated into the reactor. This can lead to a risk of explosion or a reduction in the heat output of the synthesis gas produced if the correct stoichiometric ratio should change due to malfunctions in the heat carrier feeding system.

In addition, a further drawback of the pyrogasification plants described above is the risk of clogging of the plant's passageways by solid and liquid waste products (TAR and CHAR). This means frequent maintenance work must be carried out to clear clogged ducts, with the obvious disadvantages this entails.

Finally, conventional down-draft reactors unfortunately produce synthesis gas (syngas) with a low calorific value, since the oxygen feeding the crucible, thus creating the heat carrier, causes combustion that generates heat and inert oxidised gaseous compounds, such as carbon dioxide or carbon monoxide, and lowers the calorific value of the synthesis gas produced to around 1200 Kcal/m³.

In addition to the above-mentioned reactors, rotary drum type reactors are also known which require, like up-draft and down-draft reactors, oxidising agents to ensure proper gasification. Unlike up-draft or down-draft reactors, in rotary drum reactors, the heat carrier for heat exchange with the carbonaceous matrix to be treated is introduced directly into the reactor.

The biggest problem with rotary drum reactors is related to the seals interposed between the reactor casing where the flue gases pass and the rotary drum. In fact, any air infiltrations inside the rotary drum drastically increase the risk of explosion.

In addition, rotary drum pyrogasification plants have reduced heat exchange efficiency between the carbonaceous matrix to be treated and the heat carrier inside the rotary drum during the step of converting the carbonaceous matrix to synthesis gas.

More specifically, the rotary drums of the pyrogasification plants described above are generally equipped with “L”- or “V”-shaped paddles, which have a reduced heat exchange surface. In today's reactors, the carbonaceous matrix always remains at the bottom of the pipe due to gravity, drastically reducing the contact and heat exchange surface area with the reactor itself.

In addition, the Applicant found that the traditional pyrogasification plants mentioned above are not very suitable for handling different types of carbonaceous matrices.

The need is therefore perceived to provide a plant for the treatment of material containing the carbonaceous matrix that can overcome the drawbacks complained of above.

The aim of the present invention is to meet the above requirements in an optimised and cost-effective manner, with a view to increasing the environmental sustainability of the plant solution.

### SUMMARY OF THE INVENTION

The above purpose is achieved by a plant for the treatment of material containing a carbonaceous matrix and the related operating method as claimed in the appended claims.

### BRIEF DESCRIPTION OF THE DRAWINGS

An embodiment is described below for a better understanding of the present invention, provided by way of non-limiting example with reference to the accompanying drawings, wherein:

FIG. 1 illustrates a plant for the treatment of material containing a carbonaceous matrix made according to the present invention, with parts removed for clarity;

FIG. 2 is a side view of the treatment station of the plant illustrated in FIG. 1, with parts removed for clarity;

FIG. 3 is a top view of the treatment station illustrated in FIG. 2, with parts removed for clarity;

FIG. 4 is section A-A illustrated in FIG. 3, with parts removed for clarity;

FIGS. 5 and 6 are a top and side view of the treatment station shown in FIG. 2, respectively, with parts in cross-section and parts removed for clarity;

FIGS. 5A and 5B illustrate two enlarged scale details of the reactor of the treatment station illustrated in FIG. 5, with parts in cross-section and parts removed for clarity;

FIG. 7 is a side view of an internal duct of the reactor of the treatment station illustrated in FIG. 2, with parts removed for clarity;

FIGS. 8 and 9 are two side views of the inner drum illustrated in FIG. 7, with parts in cross-section and parts removed for clarity;

FIG. 10 is section B-B illustrated in FIG. 7, with parts removed for clarity;

FIGS. 11 and 12 are respectively a top and front view of the combustor and burner of the treatment station illustrated in FIG. 2, with parts removed for clarity;

FIG. 13 illustrates the gas refining station of the plant illustrated in FIG. 1, with parts removed for clarity;

FIG. 14 illustrates the liquid refining station illustrated in FIG. 1, with parts removed for clarity;

FIG. 15 schematically illustrates the operation of the reactor of the treatment station illustrated in FIG. 2; and.

FIG. 16 schematically illustrates the operation of the decanter of the carbonaceous matrix treatment station illustrated in FIG. 2.

### DETAILED DESCRIPTION OF THE INVENTION

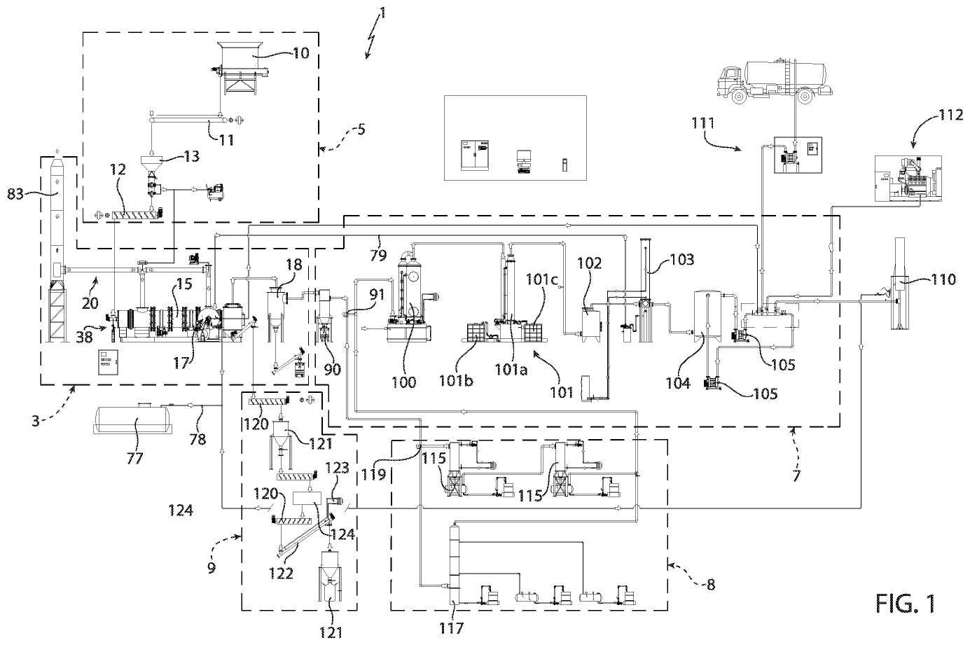

With reference to FIG. 1, the number 1 denotes a plant for the treatment of material containing a carbonaceous matrix advantageously by a pyrolysis and subsequent cracking/thermal shock process, and for the production of high-energy products such as synthesis gases (syngas), biofuels, carbon-based by-products or inert material and energy, advantageously from waste materials containing a carbonaceous matrix, such as biomasses, phytomasses, municipal or special waste, end-of-life tyres, sewage sludge, industrial sludge, hydrocarbon sludge, plastic material and/or the like.

The plant 1, in particular, is advantageously configured to use only inert gases as a heat transfer fluid to trigger the thermochemical decomposition process of the material to be processed. In other words, the plant 1 is advantageously configured not to use oxidising agents during the thermochemical decomposition of the material to be processed.

With reference to FIG. 1, the plant 1 firstly comprises a treatment station 3, which is configured to receive as input material to be processed, containing a carbonaceous matrix, and to thermochemically decompose this material advantageously through a pyrolysis and subsequent thermal cracking process.

The treatment station 3, in particular, is configured to provide an output of gaseous products such as synthesis gas, liquid products such as pyrolysis oil (TAR) and/or solid products such as pyrolysis ash (CHAR) obtained from the material containing the carbonaceous matrix.

In more detail, the treatment station 3 is configured in such a way that it can supply products in the gaseous state only and residues in the solid state, or products in both the gaseous and solid and liquid state, depending on the operating conditions of the plant 1, as described in detail below.

Preferably, the material to be processed received as input from the treatment station 3 is in the solid state, and is advantageously broken up into granules.

In addition, the plant 1 also comprises a feeding station 5, which is located upstream of the treatment station 3, and is adapted to convey the material to be transformed to the treatment station 3.

Referring to the example illustrated in FIG. 1, the plant 1 preferably also comprises a gas refining station 7, which is arranged downstream of the treatment station 3 and is configured to refine the synthesis gas supplied as output from the treatment station 3, so as to provide as output a refined synthesis gas adapted to be used for automotive purposes, to be introduced into the grid together with methane and/or to be used for feeding motor generators, turbines, boilers or steam generators for the production of electricity.

In addition, the plant 1 preferably also comprises a liquid refining/distillation station 8, which is arranged downstream of the treatment station 3, preferably in parallel with the gas refining station 7, and is adapted to supply eco-fuels, biofuels from the liquid products, i.e. pyrolysis oil, received as input from the treatment station 3.

With reference to the example illustrated in FIG. 1, moreover, the plant 1 preferably also comprises a solids refining station 9, which is arranged downstream of the treatment station 3, preferably in parallel with the gas refining station 7 and/or the liquid refining station 8, and is adapted to supply activated carbon, carbon black, agricultural soil improvers (biochar) as output from the solid products, i.e. pyrolytic ash received as input from the treatment station 3.

With reference to the example illustrated in FIG. 1, in particular, the feeding station 5 preferably comprises a loading hopper 10, which is adapted to receive as input the material to be transformed, and a belt conveyor 11 arranged downstream of the loading hopper 10.

In addition, the feeding station 5 preferably also comprises a screw conveyor 12, which is arranged downstream of the belt conveyor 11 and is adapted to feed the material to be processed to the treatment station 3.

Preferably, the feeding station 5 also comprises valve means 13, which are interposed between the belt conveyor 11 and the screw conveyor 12 and are adapted to selectively obstruct the passage of the material to be processed from the belt conveyor 11 to the screw conveyor 12.

More specifically, the valve means 13 preferably comprise an alternating damper/shutter opening and closing device, such as a double-clapet valve, advantageously equipped with its own loading hopper arranged immediately downstream of the belt conveyor 11.

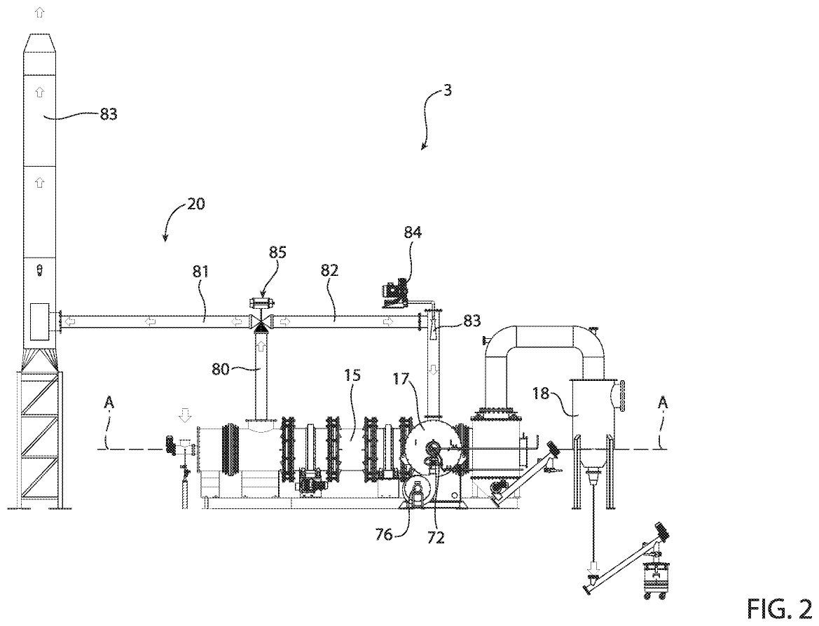

With reference to the example illustrated in FIGS. 1, 2 and 3, in particular, the treatment station 3 firstly comprises a reactor 15 that is adapted to receive the carbonaceous matrix to be transformed, and is configured to chemically decompose said carbonaceous matrix advantageously via a pyrolysis and subsequent thermal cracking process, as described in detail below.

In more detail, the reactor 15 extends along a reference axis A and is adapted to receive the carbonaceous matrix to be treated as input through a first opening located at a first axial end of said reactor 15.

Preferably, the reactor 15 is stably fixed to the ground by means of a self-supporting ground resting base 16.

In addition, the treatment station 3 also comprises a combustor assembly 17, which is advantageously arranged adjacent to the reactor 15, is fluidly connected to the same reactor 15, and is configured to feed a flow of a hot heat transfer fluid into the reactor 15 to trigger the pyrolysis and cracking/thermal shock reaction of the carbonaceous matrix.

In particular, the combustor assembly 17 is adapted to feed the heat transfer fluid into the reactor 15 through a second opening located at an axial end of the reactor 15 opposite the first end, so that the heat exchange between the material to be transformed and the heat transfer fluid triggers the thermochemical decomposition process of the same material to be transformed.

With reference to the embodiment illustrated in FIG. 1, the reactor 15 is arranged in an approximately horizontal position.

More specifically, the reactor 15 is preferably arranged in a transverse position to a horizontal reference plane orthogonal to the gravity vector.

In particular, the reactor 15 is preferably arranged in such a way that the reference axis A defines a predetermined angle with respect to said horizontal reference plane, so as to facilitate the flow of material to be transformed within the reactor 15 itself.

Preferably, the reactor 15 is arranged in such a way that the reference axis A defines an angle of less than 15° with the horizontal reference plane, and more conveniently about 5°.

It is understood that, in a different embodiment, the reactor 15 could also be arranged in a vertical position, i.e. with the reference axis A orthogonal to the horizontal reference plane, advantageously with the first inlet opening of the carbonaceous matrix arranged upwards and the second inlet opening of the heat transfer fluid arranged downwards.

Furthermore, the treatment station 3 preferably also comprises a settling/filtration device 18 which is arranged immediately downstream of the reactor 15 and is adapted to receive as input the synthesis gas and possibly other gaseous products supplied as output by the reactor 15. The settling device 18, in particular, is configured to remove any solid particulate matter suspended within the synthesis gas received as input from the reactor 15.

Preferably, the gas refining station 7 and the liquid refining station 8 are connected downstream of the settling device 18.

In addition, the treatment station 3 also comprises a gas discharge and bypass/recirculation line 20, which is configured to discharge into the environment part of the heat transfer fluid generated by the combustor assembly 17 that has passed through the reactor 15, and to recirculate part of the same heat transfer fluid back to the combustor assembly 17.

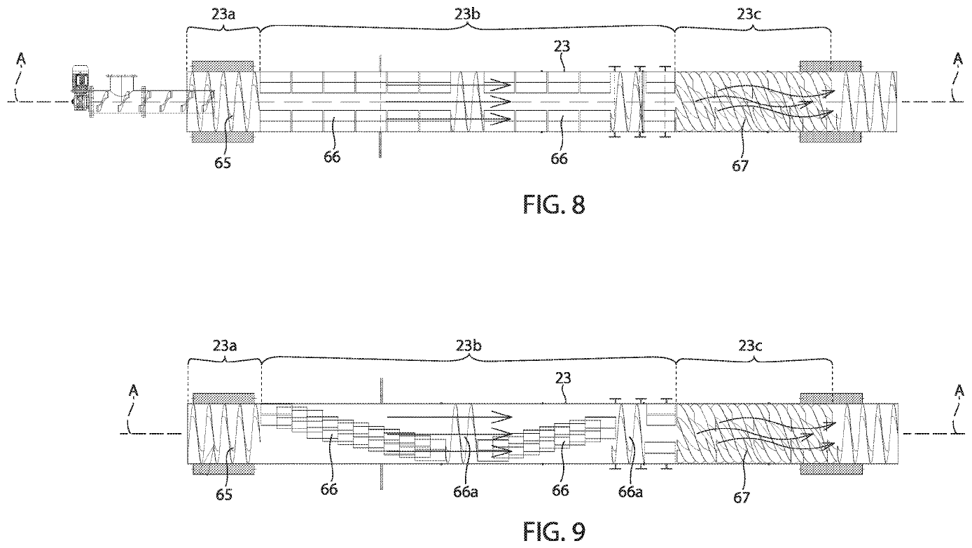

With reference to the example illustrated in FIGS. 1 to 10, in particular, the reactor 15 first comprises a hollow outer tubular casing 22, which extends along the reference axis A and is preferably made of metal material.

In particular, the casing 22 is preferably substantially cylindrical in shape and preferably made of carbon steel or AISI 304 steel.

In addition, the reactor 15 comprises a tubular reaction duct 23, or pipe or drum, which is housed inside the casing 22 in an axially rotatable manner, so that it can rotate freely about the reference axis A.

The reaction duct 23 is hollow and defines within it a reaction chamber 24 that is suitable for the material to be processed to pass through, so that this material can be decomposed advantageously by a process of pyrolysis and subsequent thermal cracking as described in more detail below.

The reaction duct 23 engages the casing 22 with clearance, so that a tubular gap is defined between the same reaction duct 23 and the casing 22.

Preferably, the reaction duct 23 is made at least in part of INCONEL (austenitic nickel-chromium alloy), in particular INCONEL 601 or a similar heat-resistant metal alloy, and at least in part of 310S stainless steel.

The reactor 15 further comprises support means 25, which are operatively interposed between the casing 22 and the reaction duct 23, and are configured to rotationally freely support the reaction duct 23 with respect to the casing 22.

In addition, the reactor 15 preferably comprises driving means 26, which are mechanically coupled to the support means 25 and are capable of driving the reaction duct 23 in rotation about the reference axis A.

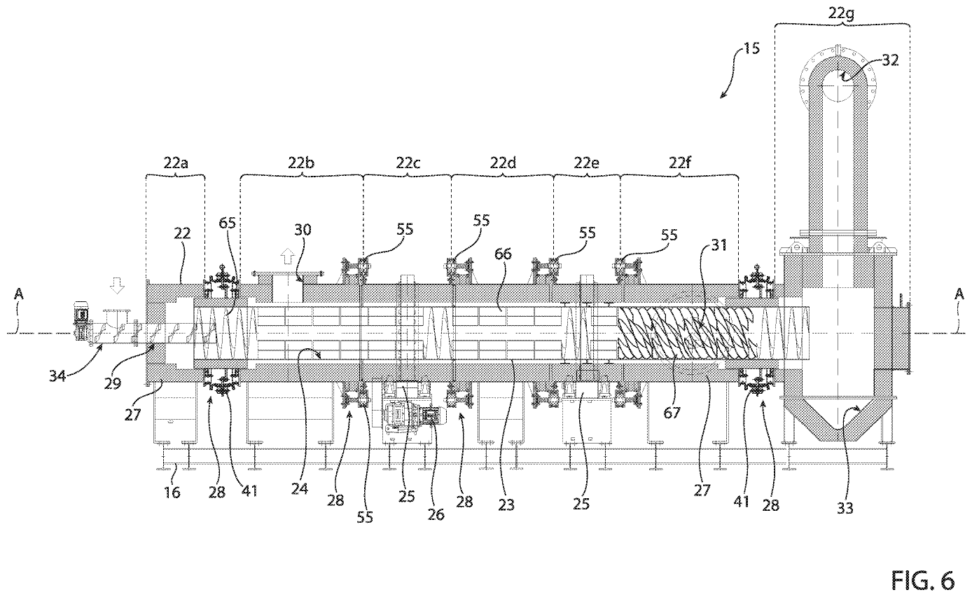

With reference to the example illustrated in FIG. 6, the reactor 15 is preferably additionally equipped with a heat insulating layer 27, which covers the inner surface of the casing 22, advantageously based on ceramic fibres.

In addition, the reactor 15 is also provided with sealing means 28, which are operatively interposed between the casing 22 and the reaction duct 23 and are configured to hermetically seal the tubular cavity and preferably also the reaction chamber 24 from the external environment, in such a way as to prevent air from entering them.

In particular, the sealing means 28 are preferably also configured to fluidly seal the reaction chamber 24 of the reaction duct 23 from the tubular gap.

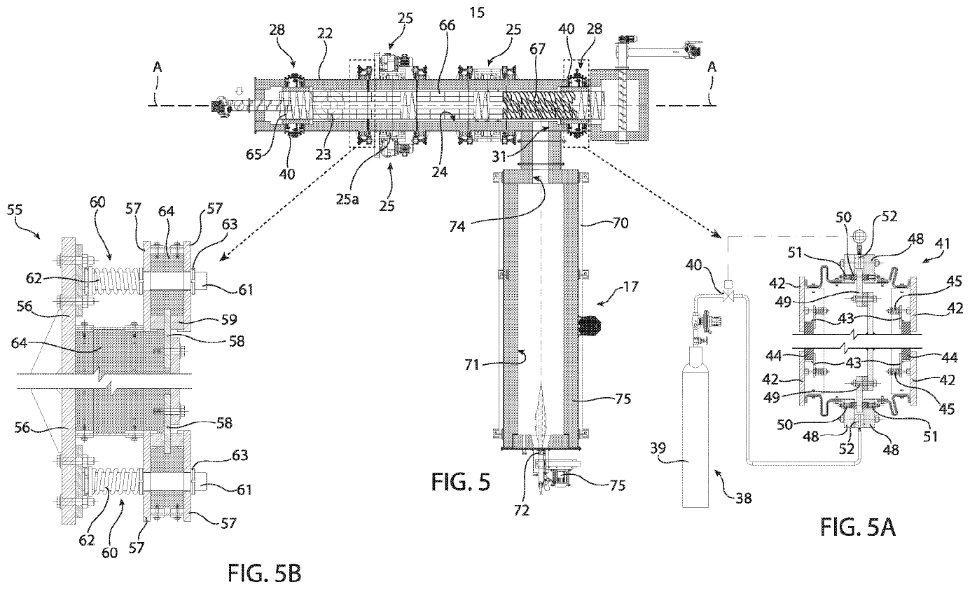

Preferably, the reactor 15 is also provided with a safety system 38 (FIGS. 1 and 5A) adapted, if necessary, to inject nitrogen or other inert gas into the reactor 15 to prevent the ignition of explosions or fires.

The safety system 38 comprises a cylinder pack 39 fluidly connected to the reactor 15 and containing nitrogen or another inert gas, and a solenoid valve 40 interposed between the cylinder pack 39 and the reactor 15 and operable to allow nitrogen to flow into the reactor 15.

With reference to the example illustrated in FIGS. 5 and 6, moreover, the casing 22 preferably comprises: an opening 29 for the inlet of the carbonaceous matrix into the reactor 15; an opening 30 for the outflow of the heat transfer fluid that has passed through the reactor 15; an opening 31 for the inlet of the heat transfer fluid supplied by the combustor assembly 17; an opening 32 for the exit of the gaseous and/or liquid products obtained in the reactor 15 and an opening 33 for the exit of the solid products obtained in the reactor 15.

Preferably, the opening 29 is located at a first axial end of the casing 22, while the openings 32 and 33 are located at a second axial end of the casing 22 opposite the first along the reference axis A.

Preferably, the opening 29 for the inlet of the carbonaceous matrix and the openings 32 and 33 for the outlet of the gaseous and solid products obtained in the reactor 15, respectively, are fluidly connected to the reaction duct 23.

More specifically, the reaction duct 23 is preferably only fluidly connected to the opening 29 for the entry of the carbonaceous matrix and the openings 32 and 33 for the outflow of the gaseous products and the solid products obtained in the reactor 15, respectively, are fluidly connected to the reaction duct 23.

The heat transfer fluid inlet opening 31 and the heat transfer fluid outlet opening 30, on the other hand, are in fluid communication with the tubular gap and are fluidly isolated from the reaction duct 23, so that the heat transfer fluid fed into the reactor 15 circulates outside the reaction duct 23 itself, in the tubular gap defined between the reaction duct 23 and the casing 22.

The opening 31 for the inlet of the heat transfer fluid is preferably located at, or adjacent to, the second axial end of the casing 22.

The opening 30 for the outflow of the heat transfer fluid is preferably located at, or adjacent to, the first axial end of the casing 22.

The sealing means 28, moreover, are preferably operationally interposed between the opening 29 and the opening 30.

In addition, the sealing means 28 are preferably operationally interposed between the opening 31 and the openings 32 and 33.

The technical effect related to the particular positioning of the sealing means 28 is to fluidly isolate the reaction chamber 24 of the reaction duct 23 from the tubular gap.

Therefore, as explained in detail below, during the operation of the plant 1, the material to be processed passes through the reaction chamber 24 in a first direction parallel to the reference axis A, starting from the first axial end towards the second axial end of the reaction duct 23, while the heat transfer fluid crosses the tubular gap, outside the reaction duct 23, in a second direction opposite to said first direction.

During use, the heat transfer fluid circulating in the tubular cavity does not come into direct contact with the carbonaceous matrix in the reaction duct 23, and the heat exchange between the two is indirect and takes place through the walls of the reaction duct 23 itself.

With reference to the example illustrated in FIGS. 5 and 6, in particular, the casing 22 preferably has a modular structure and preferably comprises a plurality of portions, which have a complementary shape and are side-by-side/adjacent along the reference axis A.

More specifically, the casing 22 preferably comprises, side by side along the reference axis A: an axial end or head portion 22a which closes the first end of the casing 22 and is provided with the opening 29; a flue gas outlet portion 22b, which is provided with the opening 30; a first support portion 22c carrying the support means 25; a fixed tubular portion 22d; a second coupling portion 22e which carries the support means 25; a flue gas inlet portion 22f which is provided with the opening 31; and finally by an end or head portion 22g which closes the second end of the casing 22 and is provided with at least the opening 32 and one opening 33.

Preferably, the end portions 22a and 22g, the flue gas outlet portion 22b, the fixed portion 22d and the flue gas inlet portion 22f are stably fixed to the self-supporting base 16.

The support portions 22c and 22e, on the other hand, are preferably carried in a rotationally free manner by the corresponding adjacent portions 22a, 22d, and 22f.

With reference to the example illustrated in FIGS. 1, 5 and 6, in particular, the axial portion 22a is preferably provided with a feed screw 34 which engages the opening 29, is positioned immediately downstream of the screw conveyor 12 of the feeding station 5 and is adapted to feed the material to be transformed into the inner duct 23.

In addition, the gas discharge and bypass/recirculation line 20 is preferably fluidly connected to the opening 30 of the flue gas outlet portion 22b.

The combustor assembly 17 is preferably fluidly connected to the opening 31 of the flue gas inlet portion 22f.

The settling device 18, on the other hand, is preferably fluidly connected to the opening 32 of the end portion 22g, while the opening 33 of the same end portion 22g is preferably connected to the solids refining line 9.

With particular reference to FIGS. 5, 6 and 7, the support means 25 preferably comprise raceways configured to support in a rotationally free manner the reaction duct 23 with respect to the casing 22.

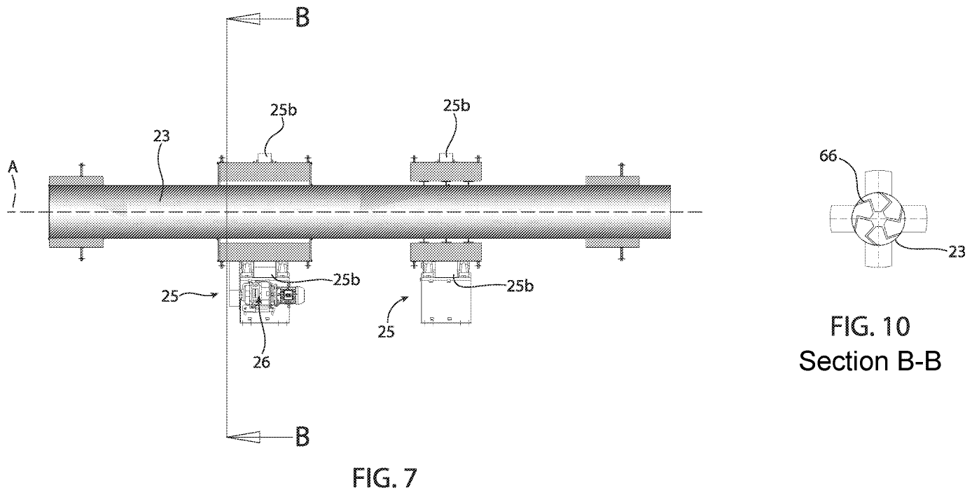

More specifically, with reference to FIGS. 5 and 7, the support means 25 preferably comprise fixed raceways 25a integral with the casing 22, and rotatable raceways 25b of a complementary shape, which are integral with the tubular duct 23 and cooperate in a rotationally free manner with the corresponding fixed raceways 25a carried by the casing 22.

In addition, at least one of the rotatable raceways 25b is preferably mechanically coupled to the driving means 26 in such a way that it can be driven in rotation about the reference axis A and draw the reaction duct 23 in rotation accordingly.

More specifically, the rotatable raceways 25b are fitted onto the reaction duct 23 in such a way as to allow the same duct to rotate about the reference axis A while locking its other degrees of freedom.

The driving means 26, on the other hand, preferably comprise at least one electric motor mechanically coupled to the support means 25, and an inverter electrically connected to the electric motor and configured to control the rotational speed of the same electric motor.

Turning now to the sealing means 28, they preferably comprise sealing devices 41 arranged at the axial ends of the reaction duct 23 and configured to fluidly isolate the reaction chamber 24 from the tubular cavity and the external environment, so that the reaction chamber is only in fluid communication with the openings 29 on one side and 32 and 33 on the other.

More specifically, the sealing devices 41 are preferably interposed, respectively, on one side between a first end of the reaction duct 23, the head portion 22a and the flue gas outlet portion 22b, and on the other side between a second end of the reaction duct 23, the flue gas inlet portion 22f and the head portion 22g.

The sealing devices 41 are configured to fluidly isolate the reaction chamber 24 of the reaction duct 23 from the tubular gap and the external environment.

Referring to the example illustrated in FIG. 5A, in particular, each sealing device 41 comprises: a pair of annular flanges 42 which extend orthogonal to the reference axis A and are integral with the casing 22; a pair of annular counter-flanges 43 arranged facing the corresponding flanges 42; a pair of annular gaskets or packings 44 which are operatively interposed between a flange 42 and a counter-flange 43, respectively, and are intended to cooperate sealingly with the reaction duct 23; and elastic means 45 configured to exert forces to maintain the counter-flanges 43 and gaskets 44 pressed against the flanges 42.

Preferably, the elastic means 45 comprise: pins or screws extending parallel to the axis A, fixed to a flange 42 and engaging in a through manner the adjacent counter-flange 43; and springs fitted to the pins and configured to exert elastic forces to press the counter-flange 43 and gasket 44 against the flange 42.

Preferably, the elastic means 45 comprise a plurality of pin and spring pairs angularly equispaced around the reference axis A.

Referring to the example illustrated in FIGS. 5 and 5A, each sealing device 41 further comprises: a pair of further annular flanges 48 which are integral with the casing 22, extend orthogonal to the reference axis A and are arranged one facing the other; an annular flange 49, which is integral with the reaction duct 23, also extends orthogonal to the reference axis A so as to engage the space/gap delimited by the two flanges 48; a pair of gaskets or packings interposed between the flange 49 and a corresponding flange 48; and elastic means 51 configured to exert forces adapted to keep the flanges 49 pressed against the flange 48.

Similar to the elastic means 45, the elastic means 51 preferably comprise: a plurality of pins or screws extending parallel to the axis A, fixed to the central flange 49 and engaging the flanges 48 in a through manner; and springs fitted to the pins and configured to exert elastic forces to press the flanges 48 and gaskets 50 against the flange 49.

Preferably, the elastic means 51 comprise a plurality of pin and spring pairs angularly equispaced around the reference axis A.

Preferably, each sealing device 41 comprises a further annular flange 52 which is interposed between the two flanges 48 and is provided with a through-hole fluidly connected to the safety system 38, so as to allow the injection of nitrogen into the reactor 15.

With reference to the example illustrated in FIGS. 5, 5B and 6, in addition, the sealing means 28 also comprise sealing devices 55 that are configured to ensure fluid-tight sealing between the casing 22 and the reaction duct 23.

In particular, the sealing devices 55 are intended to ensure fluid-tight sealing between the fixed portions of the casing 22 and corresponding rotating portions of the same casing 22 coupled to the reaction duct 23.

More specifically, the sealing devices 55 are preferably respectively interposed between the flue gas outlet portion 22b and the first support portion 22c, between the first support portion 22c and the fixed portion 22d, between the fixed portion 22d and the second support portion 22e, and finally between the second support portion 22e and the flue gas inlet portion 22f.

Referring to the example illustrated in FIG. 5B, in particular, each sealing device 55 comprises: a fixed annular flange 56, which extends orthogonal to the reference axis A and is integral with the casing 22; a pair of gasket-holder annular counter-flanges 57, which extend orthogonal to the reference axis A and are arranged in a position facing the flange 56, side by side; an annular flange 58, which is integral with the reaction duct 23, extends orthogonal to the reference axis A and engages the space/gap delimited by the two counter-flanges 57; a pair of annular gaskets or packings 59 which are operatively interposed between a counter-flange 57 and the flange 58 respectively; and elastic means 60 configured to exert forces to keep the counter-flanges 57 and the gaskets 59 pressed against the flange 59.

Preferably, the elastic means 60 comprise: pins or screws 61 which extend parallel to the axis A, are fixed to the flange 56, and engage in a through manner both the facing counter-flanges 57; and springs 62 fitted to the pins 61 and configured to exert elastic forces to press the counter-flange 57 integral with the casing 22 and the gaskets 59 against the flange 58 integral with the reaction duct 23.

Preferably, the elastic means 60 comprise a plurality of pairs of pins 61 and springs 62 angularly equispaced around the reference axis A.

The sealing devices 55 preferably comprise ferrules 63 which are interposed between the flanges 57 and the pins 61 and are configured to keep the flanges 57 coplanar and orthogonal to the reference axis A.

In addition, the sealing devices 55 preferably also comprise heat-insulating layers 64 based on ceramic fibres which are arranged in the gaps defined between the flanges 57 and the flanges 56 and 58, respectively, so as to thermally insulate the sealing devices 55 themselves.

The sealing devices 55 also comprise silicone-based insulating layers interposed between the flanges 57 and between flanges the 56 and 58, respectively, so as to hermetically seal the sealing devices 55 themselves.

Turning now to the reaction duct 23, with reference to FIGS. 5 to 10, it preferably comprises within it an screw conveyor 65, which is located at a first axial end portion 23a of the tubular duct 23 facing the opening 29, and is adapted to draw the material to be transformed into the tubular duct 23 along the reference axis A, advantageously drying the same material due to the high operating temperatures in the reaction duct 23.

Preferably, the screw conveyor 65 comprises one or more propellers carried by the inner tubular surface of the reaction duct 23 and coaxial to the reference axis A.

In addition, the reaction duct 23 preferably comprises a plurality of vanes 66, which are carried by the inner tubular wall of the reaction duct 23 and are adapted to draw the carbonaceous matrix into the reaction duct 23 along the reference axis A.

The vanes 66 are preferably plate-like and preferably protrude into the reaction tube 23.

The vanes 66 are distributed along a central portion 23b of the reaction duct 23 adjacent to the end portion 23a.

In addition, the vanes 66 are oriented transversely to the reference axis A.

In more detail, the vanes 66 are oriented in such a way as to define an angle with the reference axis A that is less than 10° and advantageously about 1°.

With reference to the example illustrated in FIGS. 5-10, the vanes 6 also have an open polygonal cross-section.

In addition, the vanes 66 are shaped and distributed along the inner surface of the reaction duct 23 in such a way as to delimit, together with the inner tubular surface of the reaction duct 23, a plurality of conduits/channels/tunnels capable of drawing the material to be processed along the reference axis A.

In use, the vanes are also adapted to distribute the carbonaceous matrix inside the tubular duct 23 along the entire inner surface/circumference thereof, maximising the contact area between the carbonaceous matrix and the tubular duct 23.

Preferably, these conduits are helical in shape and run coaxial to the reference axis A.

These conduits/channels/tunnels, in use, are adapted to collect the material to be processed and to draw it into the reaction duct 23 along the reference axis A, in contact with the inner tubular surface of the same reaction duct 23.

During the drawing of the carbonaceous matrix along the central portion 23a, the indirect heat exchange between the carbonaceous matrix and the hot heat transfer fluid fed into the tubular gap by the combustor assembly 17 triggers the thermochemical decomposition, i.e. pyrolysis, of the carbonaceous matrix.

Consequently, along the central portion 23b, the carbonaceous matrix is decomposed and gives rise to synthesis gas, pyrolysis oil and/or pyrolysis ash.

The helical shape of the conduits delimited by the vanes 66, in particular, allows the contact area with the carbonaceous matrix to be transformed to increase the heat exchange with it.

Preferably, the reaction duct 23 also comprises within it intermediate screw conveyors 66a, which are arranged along the central portion 23b and may be axially interposed between the vanes 66 and/or be arranged immediately downstream of the vanes 66.

With reference to the example illustrated in FIGS. 5-10, the reaction duct 23 also comprises within it a heat exchanger 67, preferably helical shaped, which is located at the flue gas inlet opening 31 and preferably extends along a second end portion 23c of the duct 23, adjacent to the portion 23b and opposite the portion 23a.

Preferably, the heat exchanger 23 comprises one or more advantageously plate-like laminar elements with a helical extension, which are carried by the inner tubular wall of the reaction duct 23, extend coaxially to the axis A, and are located in a position immediately facing the flue gas inlet opening 32. In particular, the laminar elements with a helical extension are preferably carried by the tubular duct 23 in such a way as to form a multiple-start helix/screw.

Similarly to the vanes 66, the exchanger 67 is also adapted in use to distribute the carbonaceous matrix inside the tubular duct 23 along its entire inner surface/circumference, maximising the contact area between the carbonaceous matrix and the tubular duct 23.

The heat exchanger 67 allows indirect heat exchange with a carbonaceous matrix at the inlet of the high-temperature heat transfer fluid immediately after it has been blown into the tubular gap outside the reaction duct 23.

In particular, due to the very high temperatures of the heat transfer fluid fed into the tubular gap at the heat exchanger 67, the latter can reach temperatures as high as 1200° C. and can trigger a thermal cracking process that increases the percentage of synthesis gas produced.

In addition, the heat exchanger 67 triggers a turbulent flow regime in the flow of synthesis gas through the 23c portion of the reaction duct 23, which increases the heat transfer coefficients between the synthesis gas and the walls of the heat exchanger 67 itself and the viscosity, thereby activating the thermal cracking process.

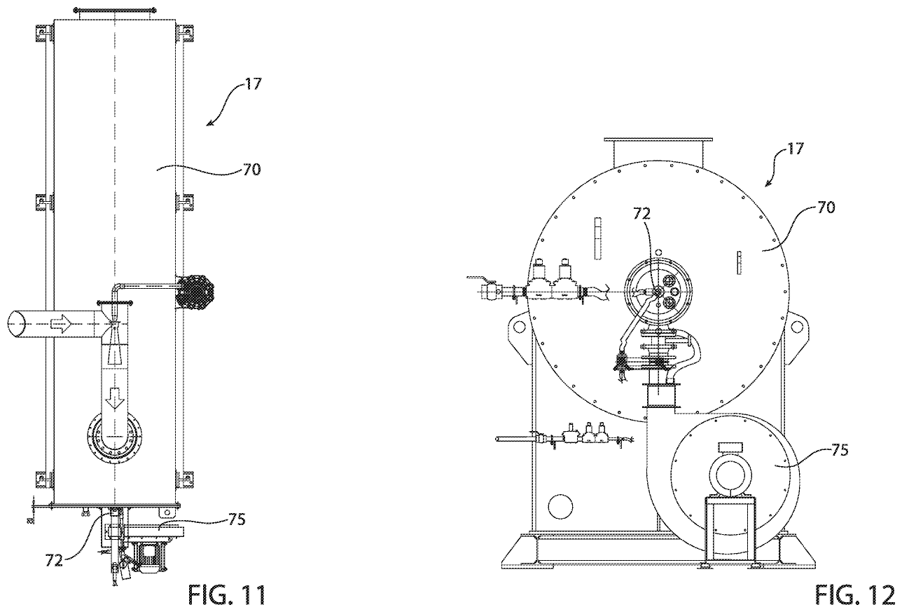

With reference to FIGS. 1-5 and 11-12, turning now to the combustor assembly 17, it comprises: a tubular casing 70, which delimits within it a combustion chamber 71 in fluid communication with the reactor 15, in particular with the tubular gap; and a burner 72, which is in fluid communication with the combustion chamber 71 and is adapted to mix a fuel and an oxidant to trigger combustion inside the combustion chamber 71, so as to produce the hot heat transfer fluid to be fed into the reactor 15, in particular into the tubular gap.

In particular, the heat transfer fluid resulting from combustion within the combustor assembly 17 comprises only inert gases. In other words, this heat transfer fluid does not comprise oxygen or other oxidising substances.

With reference to the example illustrated in FIGS. 5 and 6, the tubular casing 70 is preferably made of metal material and preferably comprises a thermal insulation layer made of ceramic fibres inside.

In addition, the tubular casing 70 is preferably arranged adjacent to, i.e. in close proximity to, the reactor 15, and is provided with an outlet opening 74 that is in fluid communication with the reactor's flue gas inlet opening 31.

Preferably, the burner 72 is a multi-fuel burner that can be fueled by methane gas, LPG (liquefied petroleum gas), diesel, pyrolysis oil, synthesis gas and/or the like.

As explained in more detail below, during the commissioning of the plant 1, the burner 72 may be fed by fuels such as methane gas, LPG, diesel or pyrolysis oil, whereas during the commissioning of the plant 1, the burner is sustained by the synthesis gas or pyrolysis oil produced within the reactor 15.

As illustrated in FIG. 1, in particular, the plant 1 is preferably equipped with a fuel tank 77 that contains LPG or another fuel and is fluidly connected to the burner 72 via a line/duct 78.

In addition, the burner 72 is preferably also fluidly connected to the liquid refining station 7 via a line/duct 79, in order to be supplied with the synthesis gas refined in the same liquid refining station 7.

In addition, the combustor assembly 17 preferably comprises a thermal insulation layer 75 preferably based on ceramic fibres, which covers the inner surface of the tubular casing 70.

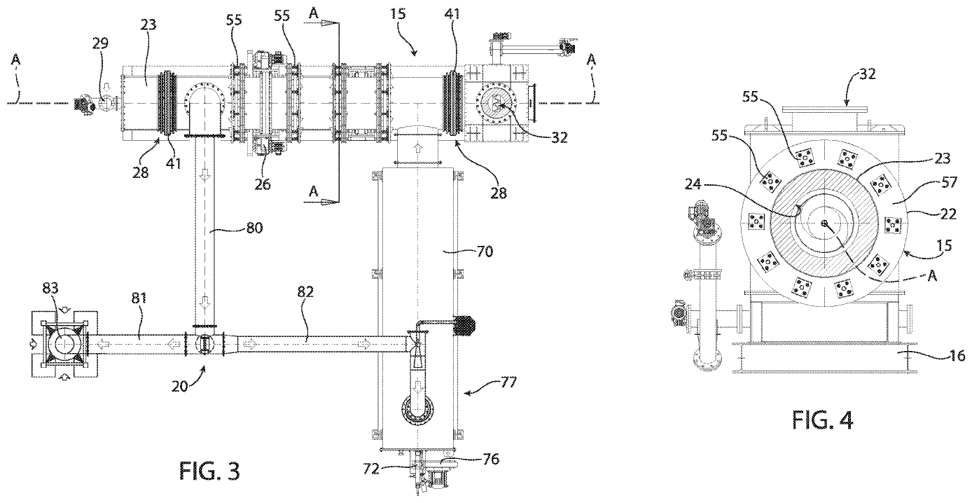

Referring to FIGS. 3, 4 and 5, in the illustrated example, the combustor assembly 17 further comprises an air intake system 76 for drawing air, i.e., the oxidant, into the combustion chamber 71.

Preferably, the air intake system comprises at least one fan driven in rotation by an electric motor, and valve means configured to regulate the flow of air blown into the combustion chamber 71 so as to regulate the correct stoichiometric ratio between the air and the oxidant fluid.

With reference to the example illustrated in FIGS. 1, 2 and 3, in addition, the gas discharge and bypass/recirculation line 20 preferably comprises an outlet pipe 80 that is fluidly connected to the opening 30 for the outflow of the hot heat transfer fluid that has passed through the reactor 15.

Preferably, the outlet pipe 80 branches into two pipes 81 and 82.

The pipe 81 is fluidly connected to a flue pipe 83 for the discharge of the heat transfer fluid into the environment.

The pipe 82, on the other hand, is fluidly connected to the combustor 17 in order to recirculate the hot heat transfer fluid back into combustor 17.

Preferably, the line 20 also comprises a venturi system 83 arranged along the pipe 82 and a blower 84 adapted to feed a flow of air into the venturi system 83, so as to depressurise the pipe 80 and suck the heat transfer fluid from the reactor 15.

In addition, the line 20 preferably also comprises a three-way valve 85 interposed between the pipes 80, 81 and 82 and adapted to distribute the heat transfer fluid drawn from the reactor 15 to the pipes 81 and 82. Preferably, the three-way valve 85 is at least partly made of INCONEL (an austenitic nickel-chromium alloy) or a similar heat-resistant metal alloy.

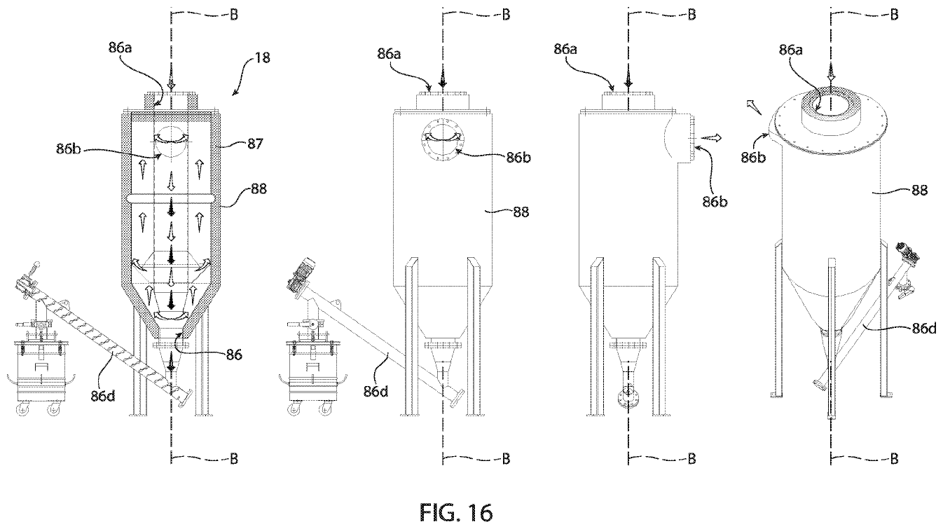

Referring to the example illustrated in FIGS. 1, 2, and 16, the settling device 18 preferably comprises a large tubular container 86 extending along a reference axis B and is preferably lined with a heat-insulating layer 87 and a casing 88 made of aluminium or another metal material.

The container 86 is preferably arranged with its reference axis B in a vertical position and is fluidly connected to the opening 32 for the outflow of liquid and gaseous products from the reactor 15.

In particular, the container 86 is preferably provided with an upper opening 86a, which is fluidly connected to the opening 32 of the reactor and allows the entry of liquid and gaseous products supplied as output from the reactor 15 into the settling device 18.

In addition, the container 88 is provided with an opening 88b for the outflow of gaseous and/or liquid products, and a lower opening 88c for the outflow of coarse solid particulate matter separated within the settling device 18.

In fact, the settling device 18 is dimensioned to cause a drastic reduction in the velocity of the solid and gaseous products inside the container 86, and thus to cause the solid particulates to be deposited on a discharge screw 85d arranged at the bottom of the container 85, downstream of the opening 85c.

With reference to the example illustrated in FIG. 1, moreover, the plant 1 is preferably provided with a microfiltration device 90, such as a multi-cyclone or other similar apparatus, fluidly connected downstream of the settling device 18 and configured to retain the micro-particulate in suspension in the gaseous and/or solid products received as input from the settling device 18.

In addition, the plant 1 further comprises a bypass valve 91, which is arranged downstream of the treatment station 3, in particular downstream of the settling device 18 and the microfiltration device 90 if provided, and is configured to allow gaseous products such as synthesis gas supplied as output from the treatment station 3 to be conveyed to the gas refining station 7, and liquid products such as pyrolysis oil to be conveyed to the liquid refining station 8.

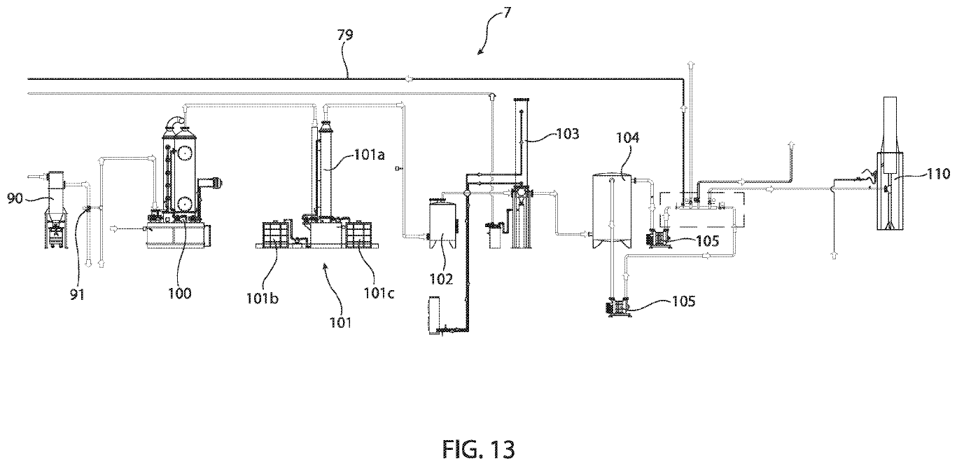

With reference to the example illustrated in FIGS. 1 and 13, the gas refining station 7 firstly comprises a scrubber tower 100 fluidly connected downstream of the bypass valve 91 and adapted to carry out an additional filtration step on the synthesis gas or other gas received as input from the bypass valve 91.

Preferably, the scrubber tower 100 is a multiple effect scrubber tower comprising a first flat tower adapted to cool the incoming synthesis gas and a second tower equipped with randomly arranged filling bodies adapted to complete the step of purifying the input gas.

Preferably, the scrubber tower 100 is also operationally connected to a chilled water source for cooling the input synthesis gas.

In addition, the gas refining station preferably also includes a desulphurisation tower 101 fluidly connected downstream of the scrubber tower 100, which is adapted to reduce the percentage of sulphur oxide contained in the gas received as input from the bypass valve 91 by means of a mixture of water and caustic soda.

The desulphurisation tower 101 comprises a washing tower 101a, a pair of tanks 101b and 101c, and circulation pumps.

The first tank 101b is adapted to contain a washing solution based on water and 30% caustic soda to perform the desulphurisation step inside the washing tower, while the second tank 101b is adapted to contain the spent washing solution. The circulation pumps, on the other hand, are adapted to feed the washing solution into the washing tower 101a and suck the spent washing solution into the tank 101b.

In addition, the gas refining station 7 preferably comprises, downstream of the desulphurisation tower 101, an activated carbon filter 102 with a structure preferably made of steel and provided with hatches for loading and unloading activated carbon.

Preferably, the gas refining station 7 further comprises a heat exchanger 103, preferably a shell and tube heat exchanger, which is connected downstream of the activated carbon filter 102, is operatively connected to a chilled water source or chiller, and is adapted to cool the gas received as input from the activated carbon filter 102.

Finally, the gas refining station 7 preferably comprises at least one tank 104 for storing the refined syngas and preferably one or more blowers 105 adapted to suck the gas to be refined from the treatment station 3.

With reference to the example shown in FIGS. 1 and 13, the plant 1 is also equipped with a safety torch located downstream of the gas treatment station 7.

Preferably, the plant 1 may also comprise, connected downstream of the tank 104, a gas compression plant 111 adapted to supply as output synthesis gas adapted for automotive purposes and/or one or more motor generators 112 for generating electricity.

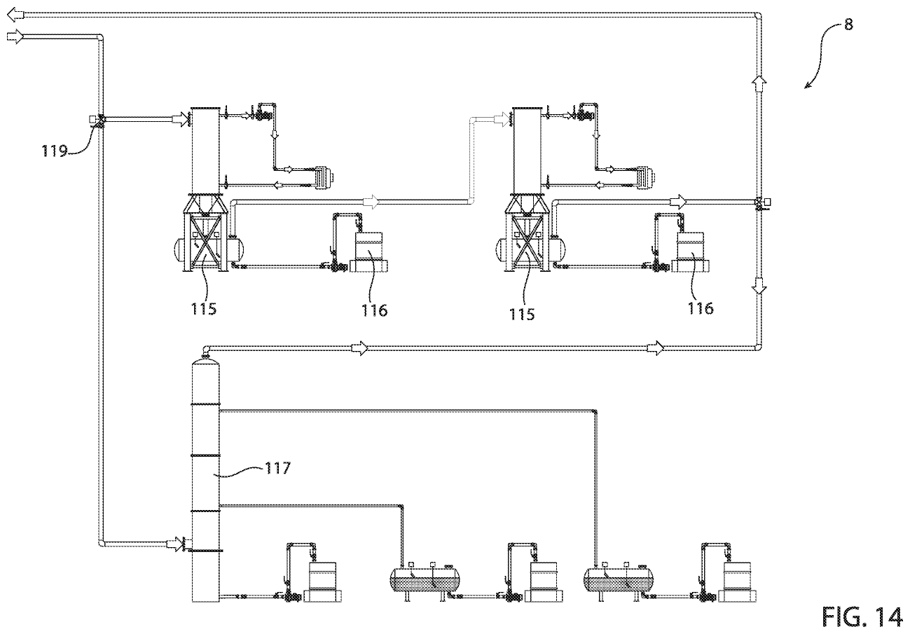

Turning now to the liquid refining station 8, with reference to FIGS. 1 and 14, it preferably comprises one or more heat exchangers 115 for condensing the pyrolysis oil received as input from the bypass valve 91 and tanks 116 for storing the condensed pyrolysis oil.

In addition, the liquid refining station 8 may also comprise one or more distillation columns 117 for the production of biofuels from the pyrolysis oil, in a manner known in itself and therefore not further described.

Preferably, the liquid treatment station 8 also comprises a bypass valve 119 to divert the pyrolysis oil received from the bypass valve 91 to the heat exchangers 115 or column 117.

Turning to the solids refining station 9, with reference to the example illustrated in FIG. 1, it preferably comprises one or more ash screw conveyors 120 adapted to collect the pyrolysis ash delivered supplied as output from the reactor 15 and convey it along the treatment station 3, one or more ash collection tanks 121, an ash cooling screw conveyor 122 operatively connected to a heat exchanger 123 (dry cooler), and an iron remover 124.

Finally, with reference to the example illustrated in FIG. 1, the plant 1 also comprises an electronic control equipment 130 which is provided with processor means programmed to control the operation of the plant 1.

In particular, the electronic control equipment 130 is adapted to drive/command at least the combustor assembly in such a way that it can regulate the temperature of the flow of heat transfer fluid fed into the reactor 15.

More specifically, the electronic control equipment is preferably configured to regulate the flow temperature of the heat transfer fluid fed into the reactor 15 in a range between 600° C. and 1300° C., and more conveniently comprised between 700° C. and 1200° C.

The operation of the plant 1 will be briefly described below.

In particular, the operation of the treatment station 3 involves introducing into the reaction chamber 24, via the opening 29 of the casing 22, the carbonaceous matrix to be treated, and at the same time introducing into the tubular gap the flow of high-temperature heat transfer fluid produced by the combustor assembly 17 through the opening 31. In addition, the operation of the treatment station 3 involves rotating the reaction duct 23, so that the carbonaceous matrix is drawn through the same conduit 23, while the flow of high-temperature heat transfer fluid externally laps the same reaction duct 23. Indirect heat exchange, via the duct 23, between the carbonaceous matrix and the heat transfer fluid triggers the pyrolysis and thermal cracking process of the carbonaceous matrix itself.

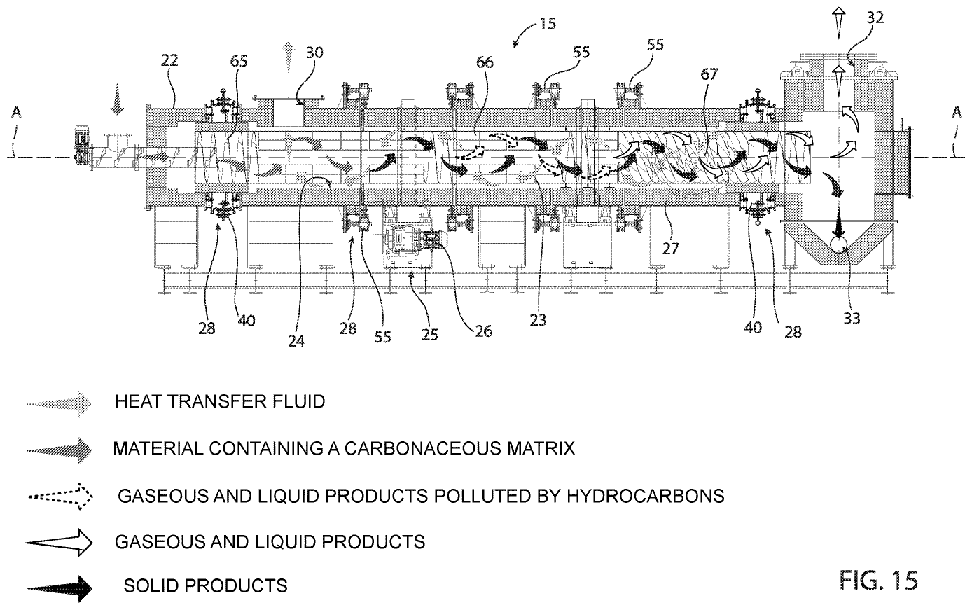

FIG. 15 schematically illustrates the operation of the reactor 15 at the treatment station 3.

According to a first method adapted to produce high quantities of synthesis gas, the operation of the plant 1 involves a first step of pyrolysis of the carbonaceous matrix and a second step of thermal cracking of the aromatic and aliphatic hydrocarbons produced during the previous pyrolysis step.

In the first operating method, in particular, the combustor assembly 17 is configured to generate the heat transfer fluid with a temperature comprised between about 1100° C. and about 1200° C.

During the first pyrolysis step, the indirect heat exchange, at the vanes 66 immediately downstream of the screw conveyor 65, between the carbonaceous matrix and the heat transfer fluid, which takes place locally at a temperature comprised between about 400° C. and 500° C., causes the pyrolysis, i.e. chemical breakdown, of the carbonaceous matrix and the consequent production of gaseous products such as pyrolysis gases, liquid such as pyrolysis oil and solids such as pyrolysis ash. This step takes place at the portion 23b of the reaction duct 23 provided with the vanes 66.

Thereafter, during the second thermal cracking step, the indirect heat exchange between the substances present in the reaction duct 23 and the heat transfer fluid which circulates in the external cavity and laps the reaction duct 23 at the heat exchanger 67, which is at a temperature comprised between about 800° C. and about 900° C., causes the thermal cracking of the aromatic and aliphatic hydrocarbons (TAR) produced during the previous pyrolysis step, i.e., the breaking of the molecular bonds of such hydrocarbons. This prevents these hydrocarbons from condensing at the outlet of the reaction duct 23 and allows for essentially complete gasification of said hydrocarbons.

In a second operating method, however, the plant 1 is configured to produce high quantities of pyrolysis oil and/or similar liquid products.

In the second operating method, the combustor assembly 17 is configured to produce the heat exchange fluid with a temperature comprised between about 600° C. and about 800° C., advantageously about 700° C.

In this second operating mode, the temperature of the heat transfer fluid during the pyrolysis step is comprised between about 300° C. and about 400° C., whereas during the subsequent shock step at the heat exchanger 67 it is comprised between about 600° C. and about 650° C. These lower temperatures compared to the first mode promote the production of tars, which benefits the production of aliphatic and aromatic hydrocarbons (TAR) and pyrolysis ash (CHAR).

The operation of the gas treatment station 7, liquid treatment station 8 and solids treatment station 9 is easily deduced from the above and will therefore not be described further.

In light of the foregoing, the present invention also relates to an operating method of the plant 1, which comprises the following steps:
a) feeding/conveying the material to be processed into the reaction duct 23 of the reactor 15 via the opening 29;
b) rotating the reaction duct 23 in such a way that the material to be processed is drawn into the reaction duct 23 itself;
c) driving the combustor assembly 17 in such a way as to generate a heat transfer fluid at a predetermined temperature; and
d) feeding the heat-transfer fluid generated during step c) into the tubular cavity outside the reaction duct 23, via the opening 31, so as to trigger the thermochemical decomposition process of the material to be processed.

According to a first operating method, step c) preferably involves driving the combustor assembly 17 in such a way as to generate the fluid flow at a temperature comprised between about 1100° C. and about 1200° C.

According to a second operating method, step c) preferably involves driving the combustor assembly 17 in such a way that the fluid flow is generated at a temperature comprised between about 600° C. and about 800° C., advantageously at a temperature of about 700° C.

The advantages associated with the plant 1 and its operating method are considerable and obvious.

Firstly, the plant 1 makes it possible to obtain synthesis gas with a high calorific value of up to 3000 kcal/m³ if obtained from biomasses and 6000 kcal/m³ if obtained from end-of-life tyres or plastics, since thanks to the special conformation of the reaction duct 23 that allows high heat exchange between the carbonaceous matrix and the heat transfer fluid, the very high temperatures of the heat transfer fluid used, and the total absence of oxidising agents within the heat transfer fluid, no inert gases such as carbon dioxide are produced, and it is possible to obtain a synthesis gas with a very high calorific power compared to that obtained through traditional pyro-gasification plants.

In particular, in use, the heat transfer fluid laps the entire outer tubular surface of the reaction duct 23, and thus heats the entire surface of the latter uniformly. This significantly increases the heat exchange, albeit indirect, between the heat transfer fluid and the carbonaceous matrix to be treated compared to conventional fluidised bed reactors, in which both the carbonaceous matrix and the heat transfer fluid pass through the rotary drum internally and the heat exchange between the two only affects a small percentage of the surface of the rotary drum itself.

According to the present invention, on the other hand, the unusual conformation of the vanes 66 and the heat exchanger 67 allows the carbonaceous matrix, when being drawn into the reaction duct 23, to be arranged/distributed over the entire outer tubular surface thereof, maximising the contact area. Together with the flow of hot heat transfer fluid that laps and completely envelops the entire tubular duct 23, it is evident that the unusual conformation of the tubular duct 23 maximises heat exchange between the carbonaceous matrix and the hot heat transfer fluid.

In addition, the operation of the plant 1 is particularly modulable and can be calibrated to produce high fractions of synthesis gas or high fractions of aliphatic and aromatic hydrocarbons without requiring changes to the plant structure, but only by modifying the operating parameters of the combustor assembly 17.

In particular, the plant 1 can be easily calibrated to produce synthesis gas, pyrolysis oil, or bio-fuels from the carbonaceous matrix used as input.

With the use of biomasses, bio-fuels can be produced, while used plastics or used tyres can be used to produce eco-fuels such as diesel, petrol and bitumen, the latter of which is used in a variety of ways in the marine sector (bunker oil) or asphalts.

A further advantage of the plant 1 is that it allows the production of synthesis gas free from critical compounds such as nitrogen oxide, sulphur oxides, acetic acid, ammonia or other viscous and insoluble by-products such as tars.

Thanks to the installation of the multi-cyclone 90, scrubber tower 100, desulphuriser 101, activated carbon filter 102 and heat exchanger 103, along the gas treatment station 7, the plant is able to eliminate the pollutants produced in the pyrolysis step and efficiently cool the synthesis gas produced.

In addition, unlike plants of the known type, where gasification takes place in a few minutes and the residence time of the combustible gas stream is very short, the carbonaceous matrix stays for a long time in the reaction duct 23, even for longer than 50 minutes, being exposed to gradually higher temperatures until it reaches 1200° C. near the opening 31, so that even heavier hydrocarbons can be gasified.

Another advantage is the fast commissioning of the plant 1 due to the use of special ceramic fibre insulation. In fact, the commissioning of the plant 1 is considerably faster than the commissioning of conventional plants with refractory cement-based thermal insulation layers.

Another advantage is related to the gas treatment station 7 is the possibility of supplying totally anhydrous synthesis gas that is perfectly free from pollutants.

In addition, the gas discharge and bypass/recirculation line 20 can recirculate up to 80% of the heat transfer fluid within the combustor assembly 17, thus reducing harmful emissions into the atmosphere by up to 20%.

Finally, the use of the safety system 38 makes it possible to significantly reduce the risks associated with the use of the plant 1.

Finally, it is clear that modifications and variations can be made to the plant 1 and its operating method, which, however, do not go beyond the scope of protection defined by the claims.

1. A plant for the treatment of material containing a carbonaceous matrix, said plant comprising:
a treatment station, which is configured to receive as input material containing a carbonaceous matrix to be transformed, and to thermochemically decompose said material into a plurality of products in the gaseous state, in the liquid state and/or in the solid state; and
a feeding station, which is arranged upstream of said treatment station and is adapted to convey said material towards said treatment station;
said treatment station comprising:
a reactor, which extends along a reference axis (A);
a combustor assembly, which is placed adjacent to said reactor and is adapted to feed into said reactor a heat transfer fluid adapted to trigger a thermochemical decomposition process of said material;
said reactor comprising:
a hollow casing, which extends along said reference axis (A);
a tubular reaction duct, which extends along said reference axis (A), is carried in a freely rotatable manner within said casing, defines inside it a reaction chamber adapted to receive said material as input through a first opening and to be passed through by said material along a first direction, and engages said casing with clearance so as to delimit a tubular gap between said casing and said tubular reaction duct, which is isolated at fluid level from said reaction chamber, is adapted to receive as input said heat transfer fluid through a second opening formed on said casing and is adapted to be passed through by said heat transfer fluid in a direction opposite said first direction;
support means configured to support in a rotationally free manner said tubular reaction duct with respect to said casing;
driving means adapted to drive in rotation said tubular reaction duct about said reference axis (A); and
sealing means, which are operatively interposed between said casing and said tubular reaction duct, and are configured to fluid-tightly seal said reaction chamber from said tubular gap;
said tubular reaction duct comprising:
a heat-exchanger, which is carried by the tubular inner wall of said tubular reaction duct, and extends coaxial to said reference axis (A) along a first end axial portion of said tubular reaction duct arranged at said second opening; and
a plurality of vanes, which are carried by the inner tubular surface of said tubular duct, at a central portion of said tubular reaction duct adjacent to said first axial end portion along said reference axis (A) and are shaped and distributed in such a manner as to delimit, together with the inner tubular surface of said tubular reaction duct, a plurality of conduits, which are adapted to draw said material towards said heat exchanger during the rotation of said tubular reaction duct about said reference axis (A).

2. The plant according to claim 1, wherein said heat exchanger is helical in shape.

3. The plant according to claim 2, wherein said heat exchanger comprises a plurality of laminar elements, which are carried by the inner tubular wall of said tubular reaction duct, are shaped in the form of a helix, and extend coaxial to said reference axis.

4. The plant according to claim 1, wherein said conduits are helical in shape and extend coaxial to said reference axis (A).

5. The plant according to claim 1, further comprising a gas refining station, which is arranged downstream of said treatment station and is configured to refine the gaseous products supplied as output by said treatment station, so as to provide refined synthesis gas as output.

6. The plant according to claim 1, further comprising a liquid refining station, which is arranged downstream of said treatment station and is configured to refine the liquid products provided as output by said treatment station, so as to provide as output pyrolysis oil and/or biofuels.

7. The plant according to claim 1, wherein said vanes extend cantilevered into said tubular reaction duct and/or are arranged transversal to said reference axis (A), so as to form an angle less than 10° with said reference axis (A).

8. The plant according to claim 1, wherein said treatment station comprises a settling device, which is arranged immediately downstream of said reactor, and is adapted to receive as input the gaseous products and/or the liquid products provided as output by said reactor, and is configured to remove any particulate matter present in suspension in said gaseous products and/or in said liquid products provided as output by said reactor.

9. The plant according to claim 1, comprising a gas discharge and recirculation line, which is in fluid connection with said reactor and said combustor assembly, and is configured to discharge into the environment a part of the heat transfer fluid after it has passed through said reactor, and to recirculate again within said combustor assembly another part of said heat transfer fluid after it has passed through said reactor.

10. The plant according to claim 1, wherein said support means comprise raceways configured to support in a rotationally free manner said tubular reaction duct with respect to said casing.

11. The plant according to claim 1, wherein said sealing means comprise first sealing devices, which are arranged at the axial ends of said reaction duct and are configured to fluid-tightly seal said reaction chamber.

12. The plant according to claim 11, wherein said first sealing devices comprise: a pair of first annular flanges, which extend orthogonal to said reference axis (A) and are integral with said casing; a pair of first annular counter-flanges, each arranged facing a corresponding first flange; a pair of first annular gaskets, which are operatively interposed between a first flange and a first counter-flange, respectively, and are adapted to sealingly cooperate with said reaction duct; and first elastic means adapted to exert forces adapted to maintain said first counter-flanges and said first gaskets pressed against said first flanges.

13. The plant according to claim 11, wherein said first sealing devices comprise: a pair of second annular flanges, which are integral with said casing, extend orthogonal to said reference axis (A) and are arranged one facing each other; a third annular flange, which is integral with said tubular reaction duct, and extends orthogonal to said reference axis (A) so as to engage the gap delimited by said second flanges; a pair of second gaskets interposed between said third flange and a corresponding second flange; and second elastic means configured to exert forces adapted to maintain said second flanges and said second gaskets pressed against said third flange.

14. The plant according to claim 1, wherein said casing has a modular structure and comprises first portions stably fixed to a ground resting base and second portions, which are carried in a rotationally free manner by said first portions and support said support means;
said sealing means comprising second sealing devices configured to fluid-tightly seal the coupling between said first portions and said second portions.

15. The plant according to claim 14, wherein said second sealing devices comprise: a fourth annular flange, which is integral with said casing and extends orthogonal to said reference axis (A); a pair of second gasket-holder annular counter-flanges, which extend orthogonal to said reference axis (A) and are arranged facing said fourth flange, side by side; a fifth annular flange, which is integral with said tubular reaction duct, extends cantilevered orthogonal to said reference axis (A) and engages the gap delimited by said second counter-flanges; third annular gaskets, which are operatively interposed between a second counter-flange and said fourth flange respectively; and third elastic means configured to exert forces adapted to maintain said second counter-flanges and said third gaskets pressed against said fifth flange.

16. The plant according to claim 1, wherein said reactor is arranged in a transverse position with respect to a horizontal reference plane, so that said reference axis (A) forms an angle with said horizontal reference plane less than or equal to 15°, in particular less than or equal to 5°.

17. An operating method of a plant made according to claim 1;
said operating method comprising:
a) feeding/conveying said material containing a carbonaceous matrix into said reaction chamber via said first opening;
b) driving in rotation said tubular reaction duct, so as to draw said material containing a carbonaceous matrix along said tubular reaction duct;
c) driving said combustor assembly so as to generate said heat transfer fluid at a predetermined temperature; and
d) feeding into said tubular gap said heat transfer fluid generated during step c) through said second opening, so that said tubular fluid may lap and heat said tubular reaction duct, so that said process of thermochemical decomposition of said material containing a carbonaceous matrix is triggered.

18. The operating method according to claim 17, wherein said step c) comprises commanding said combustor assembly in order to generate said heat transfer fluid with a temperature comprised from 1100° C. to 1200° C.

19. The operating method according to claim 17, wherein said step c) comprises commanding said combustor assembly in order to generate said heat transfer fluid with a temperature comprised from 600° C. to 800° C.
